(19) United States
(12) Patent Application Publication
(10) Pub. No.: US 2024/0120474 A1
(43) Pub. Date: Apr. 11, 2024

(54) FLEXIBLE ELECTRODE MATERIAL AND PREPARATION METHOD THEREFOR

(71) Applicant: INDUSTRY-ACADEMIC COOPERATION FOUNDATION GYEONGSANG NATIONAL UNIVERSITY, Gyeongsangnam-do (KR)

(72) Inventors: Geon Hyoung AN, Gyeongsangnam-do (KR); Young Geun LEE, Incheon (KR); Jae Yeon LEE, Gyeongsangnam-do (KR)

(73) Assignee: INDUSTRY-ACADEMIC COOPERATION FOUNDATION GYEONGSANG NATIONAL UNIVERSITY, Gyeongsangnam-do (KR)

(21) Appl. No.: 18/265,957

(22) PCT Filed: Nov. 19, 2021
(86) PCT No.: PCT/KR2021/017064

§ 371 Date: Jun. 7, 2023

(30) Foreign Application Priority Data
Dec. 17, 2020 (KR) 10-2020-0177030

(51) Int. Cl. H01M 4/50; H01M 4/04; H01M 4/66; H01M 10/36

(52) U.S. Cl. CPC H01M 4/50; H01M 4/049; H01M 4/663; H01M 10/36

(57) ABSTRACT

The present invention relates to a flexible electrode material and a preparation method therefor. An aspect of the present invention provides a flexible electrode material comprising a graphene film and a free-standing metal oxide formed on the graphene film.

### TECHNICAL FIELD

The following description relates to a flexible electrode material and a method for preparing the same.

### BACKGROUND ART

Zinc-ion batteries are composed of a zinc anode, an oxide cathode, an electrolyte, and a separator, and are attracting attention as a next-generation flexible portable energy storage device by having excellent stability, eco-friendliness, and high specific capacity.

In particular, zinc, as a key electrode material for zinc-ion batteries, has advantages in that it is a very safe material, has low cost, and is environmentally friendly at the same time. It not only is relatively stable compared to lithium, sodium, and potassium, but also has a high theoretical capacity and excellent compatibility with electrolytes so that high energy density and long lifespan of the batteries can be realized.

In the energy storage mechanism of the zinc-ion batteries, zinc ions are intercalated and deintercalated from the cathode to the zinc electrode during charging, and zinc ions are intercalated and deintercalated from the cathode during discharging.

At this time, the degree of storage of zinc ions in the cathode is the most important factor in determining the energy storage performance of the zinc-ion batteries, and it is very important to select an appropriate cathode material.

In this regard, vanadium-based electrode materials such as VS₂, V₂O₅ and VO₂ having high specific capacity and excellent long-term stability have been studied, but there is a problem in that the application is difficult due to high cost and toxicity.

In comparison, manganese oxide has advantages such as low costs, compliant theoretical capacity, and high operating voltage, and thus shows characteristics suitable as an electrode material for zinc-ion batteries, but due to the use of a binder and a metal current collector, rapid capacity deterioration occurs, and low cycling stability is exhibited.

Therefore, it is necessary to develop an electrode material capable of improving capacity retention rate, cycling stability, etc. while securing excellent energy storage ability of the zinc-ion batteries.

The aforementioned background art is possessed or acquired by the inventor in the process of deriving the disclosure of the present application, and cannot necessarily be said to be publicly known art disclosed to the general public prior to the present application.

### DISCLOSURE OF THE INVENTION

### Technical Goals

The present disclosure is to solve the above-described problems, and an aspect of the present disclosure is to provide a flexible electrode material capable of improving energy storage performance, capacity retention rate, and cycling stability of a zinc-ion battery, and a method for preparing the same.

However, technical goals to be achieved are not limited to those described above, and other goals not mentioned above are clearly understood by one of ordinary skill in the art from the following description.

### Technical Solutions

One aspect of the present disclosure provides a flexible electrode material including: a graphene film; and a free-standing metal oxide formed on the graphene film.

According to one embodiment, the graphene film may contain graphene or a plurality of stacked graphenes.

According to one embodiment, the graphene film may be surface-activated so that a functional group containing oxygen (O) exists on a surface.

According to one embodiment, the metal oxide may include one or more selected from the group consisting of α-MnO₂, β-MnO₂, γ-MnO₂, δ-MnO₂, V₂O₅, and V₂O₅·nH₂O.

The metal oxide may be contained in an amount of 1% by weight to 10% by weight.

According to one embodiment, the metal oxide may have a length of 10 nm to 200 nm in a direction perpendicular to the surface of the graphene film.

According to one embodiment, the metal oxide may be directly bonded to the surface of the graphene film.

According to one embodiment, the flexible electrode material may be binder-free.

According to one embodiment, the electrode may be for a zinc-ion battery.

Another aspect of the present disclosure provides a method for preparing a flexible electrode material, the method including the steps of: preparing a mixed solution by dissolving graphene and polyvinylidene difluoride (PVDF) in a solvent; casting the mixed solution on a mesh and heating it to form a graphene film; separating the graphene film from the mesh; and floating the graphene film on a metal oxide precursor solution and then stirring the metal oxide precursor solution.

According to one embodiment, the mixed solution may be cast on a mesh by a doctor blade method, and the heating may be performed at a temperature of 50° C. to 150° C.

According to one embodiment, it may further include a step of surface-activating the separated graphene film after the step of separating the graphene film from the mesh.

According to one embodiment, the metal oxide may be manganese oxide, and the metal oxide precursor solution may contain potassium permanganate (KMnO₄), sulfuric acid (H₂SO₄), and deionized water (DIW).

According to one embodiment, the stirring may be performed for 30 minutes to 90 minutes.

### Effects

The flexible electrode material according to the present disclosure directly forms a free-standing metal oxide on a graphene film to have an effect of improving energy storage performance, capacity retention rate, and cycling stability, and have an effect of excellent flexibility and waterproofness.

In addition, the method for preparing a flexible electrode material according to the present disclosure selectively grows a metal oxide on a graphene film without a binder or an additive, thereby having an advantage in that an electrode material capable of solving problems such as a decrease in battery capacity and low cycling stability due to the binder and having excellent flexibility and electrochemical performance may be prepared in a relatively simple manner.

Furthermore, the zinc-ion battery including the flexible electrode material according to the present disclosure may have excellent electrochemical performance, stability, flexibility, and waterproof characteristics, and has an effect in that it may be implemented as both an aqueous zinc-ion battery and an all-solid-state zinc-ion battery.

### BRIEF DESCRIPTION OF DRAWINGS

FIG. 1 is a diagram showing a preparation process of a flexible electrode material according to one embodiment of the present disclosure.

FIG. 2 is a diagram showing a structural form of an electrode material according to one embodiment of the present disclosure.

FIGS. 3A to 3I are images showing morphological and structural characteristics of a flexible electrode material according to one embodiment of the present disclosure.

FIG. 3A is a photograph showing a flexed condition of a surface-activated graphene film.

FIGS. 3B and 3E are FE-SEM images of surface-activated graphene films.

FIGS. 3C and 3G are FE-SEM images of the flexible electrode material of Example 1.

FIGS. 3D and 3H are FE-SEM images of the flexible electrode material of Example 2.

FIGS. 3E and 3I are FE-SEM images of the flexible electrode material of Example 3.

FIGS. 4A and 4B are cross-sectional FE-SEM images of the flexible electrode material of Example 2 according to one embodiment of the present disclosure.

FIG. 4A is a cross-sectional FE-SEM image (scale bar 500 nm) of the flexible electrode material of Example 2 according to one embodiment of the present disclosure.

FIG. 4B is a cross-sectional FE-SEM image (scale bar 50 nm) of the flexible electrode material of Example 2 according to one embodiment of the present disclosure, which is an enlarged view of the rectangular marked portion of FIG. 4A.

FIGS. 5A to 5C are HR-TEM images and EDS mapping images of the flexible electrode material of Example 2 according to one embodiment of the present disclosure.

FIG. 5A is a low-resolution HR-TEM image of the flexible electrode material of Example 2.

FIG. 5B is a high-resolution HR-TEM image of the flexible electrode material of Example 2, which is an enlarged view of the rectangular marked portion of FIG. 5A.

FIG. 5C is EDS mapping images of the flexible electrode material of Example 2.

FIGS. 6A to 6D are TGA, XRD, and XPS results of a flexible electrode material according to one embodiment of the present disclosure.

FIG. 6A is a TGA result of a flexible electrode material according to one embodiment of the present disclosure.

FIG. 6B is an XRD result of a flexible electrode material according to one embodiment of the present disclosure.

FIG. 6C is an XPS result of a flexible electrode material according to one embodiment of the present disclosure.

FIG. 6D is an XPS result of a flexible electrode material according to one embodiment of the present disclosure.

FIGS. 7A to 7C are results of analyzing the electrochemical properties of coin cells manufactured of electrode materials of Comparative Example and Examples 1 to 3 in which a commercialized MnO₂ powder, a PVDF binder, and conductive carbon black (Ketjen black) are cast on a surface-activated graphene film.

FIG. 7A is a Nyquist plot of cells manufactured using the electrode materials of Comparative Example and Examples 1 to 3.

FIG. 7B is a graph showing the relationship between Zᵣₑₐₗ and [symbol] in cells manufactured using the electrode materials of Comparative Example and Examples 1 to 3.

FIG. 7C is a graph showing Zn-ion diffusion coefficients of cells manufactured using the electrode materials of Comparative Example and Examples 1 to 3.

FIGS. 8A and 8B are graphs showing the electrochemical performance of cells manufactured using the electrode materials of Comparative Example and Examples 1 to 3.

FIG. 8A shows the rate performance of cells manufactured using the electrode materials of Comparative Example and Examples 1 to 3 at potentials in a range of 1.0 to 1.9 V and current densities in a range of 0.1 to 2.0 Ag⁻¹.

FIG. 8B is a graph showing the capacity changes during 300 cycles at a current density of 1.0 Ag⁻¹ of cells manufactured using the electrode materials of Comparative Example and Examples 1 to 3.

FIG. 9 compares the energy and power densities of the cell manufactured using the electrode material of Example 2 with other reported energy storage devices using an electrolyte solution by Ragone plot.

FIG. 10 shows a schematic diagram of the structure of an all-solid-state zinc ion battery using a flexible electrode material wheat gel electrolyte according to one embodiment of the present disclosure.

FIGS. 11A to 11C show life performance and cycling stability of an all-solid-state zinc ion battery using a flexible electrode material wheat gel electrolyte according to one embodiment of the present disclosure.

FIG. 11A shows the rate performance of an all-solid-state zinc ion battery according to one embodiment of the present disclosure at a potential in a range of 1.0 to 1.9 V and a current density in a range of 0.3 to 1.0 Ag⁻¹.

FIG. 11B is a Ragone plot comparing the energy and power densities of an all-solid-state zinc ion battery according to one embodiment of the present disclosure with previously reported all-solid-state energy storage devices.

FIG. 11C shows cycling stability at a current density of 0.5 Ag⁻¹ under conditions of flat and folded states and the presence and absence of water of an all-solid-state zinc ion battery according to one embodiment of the present disclosure.

FIG. 12 is photographs of experiment confirming whether or not the all-solid-state zinc ion battery according to one embodiment of the present disclosure operates under water and in a flexed condition.

### BEST MODE FOR CARRYING OUT THE INVENTION

Hereinafter, examples will be described in detail with reference to the accompanying drawings. However, since various changes may be made to the examples, the scope of rights of the patent application is not restricted or limited by these examples. It should be understood that all modifications, equivalents and substitutes for the examples are included in the scope of the rights.

The terms used in the examples are used for the purpose of description only, and should not be construed as an intention to limit the present disclosure. The singular expression includes the plural expression unless the context clearly dictates otherwise. In the present specification, it should be understood that a term such as “include”, “have”, or the like is intended to designate that a feature, a number, a step, an operation, a component, a part, or a combination thereof described in the specification exists, but it does not preclude the possibility of existence or addition of one or more other features, numbers, steps, operations, components, parts, or combinations thereof.

Unless defined otherwise, all terms used herein, including technical or scientific terms, have the same meaning as those commonly understood by one of ordinary skill in the art to which the examples belong. Terms such as those defined in a commonly used dictionary should be interpreted as having a meaning consistent with the meaning in the context of the related art, and should not be interpreted in an ideal or excessively formal meaning unless explicitly defined in the present application.

Further, in the description with reference to the accompanying drawings, the same constituent elements are assigned the same reference numerals regardless of the reference numerals, and the overlapping description thereof will be omitted. In the description of the examples, if it is determined that a detailed description of a related known technology may unnecessarily obscure the gist of the examples, the detailed description will be omitted.

Further, in describing constituent elements of the embodiments, terms such as first, second, A, B, (a), (b), etc. may be used. These terms are only for distinguishing the constituent elements from other constituent elements, and essences, orders, sequences, or the like of the corresponding constituent elements are not limited by the terms. When it is described that a constituent element is “linked”, “coupled” or “connected” to the other constituent element, the constituent element may be directly linked or connected to the other constituent element, but it should be understood that another constituent element may also be “linked”, “coupled” or “connected” between the respective constituent elements.

Constituent elements included in any one embodiment and constituent elements including a common function will be described using the same names in other embodiments. Unless otherwise stated, descriptions described in any one embodiment may also be applied to other embodiments, and detailed descriptions will be omitted within the overlapping range.

One aspect of the present disclosure provides a flexible electrode material including: a graphene film; and a free-standing metal oxide formed on the graphene film.

The flexible electrode material according to the present disclosure is characterized in that it not only has flexibility, but also has improved electrochemical performance since a metal oxide is bonded to a surface of the graphene film without a binder.

In the flexible electrode material according to the present disclosure, charge mobility is improved by not including a binder, and zinc-ion diffusion capability may be improved by uniformly forming a free-standing metal oxide on the graphene film.

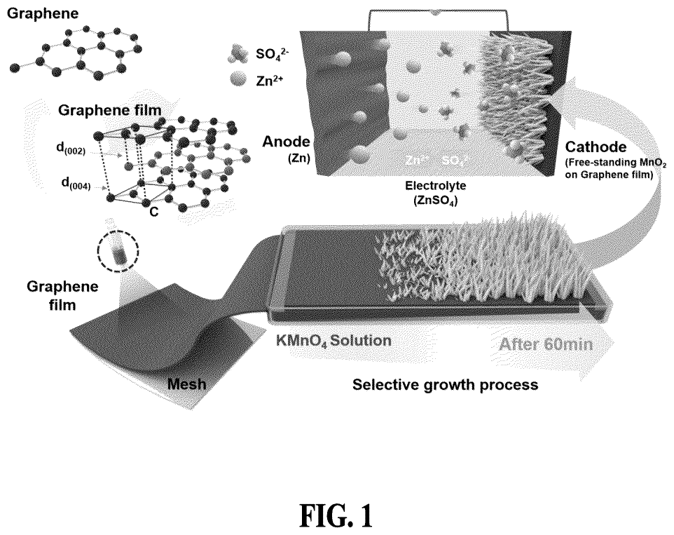

FIG. 1 is a diagram showing a preparation process of a flexible electrode material according to one embodiment of the present disclosure.

Referring to FIG. 1, a flexible electrode material may be obtained by selectively growing manganese dioxide (MnO₂), which is a metal oxide, on a graphene film.

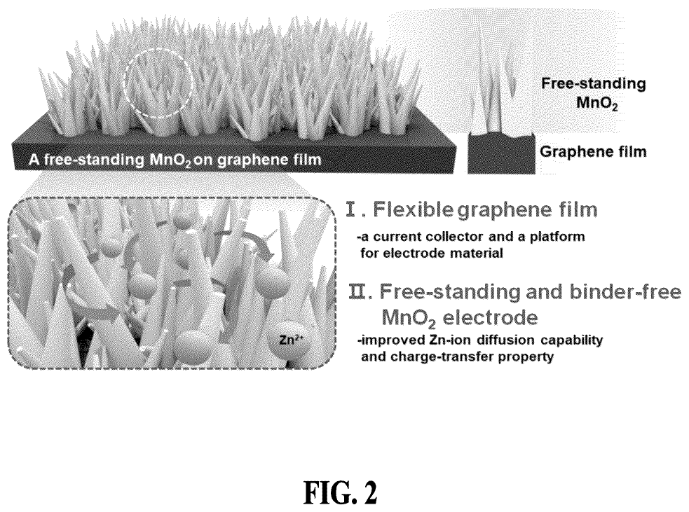

FIG. 2 is a diagram showing a structural form of an electrode material according to one embodiment of the present disclosure.

Referring to FIG. 2, in the flexible electrode material according to one embodiment of the present disclosure, the graphene film having flexibility serves as a current collector and a platform that are capable of uniformly growing a metal oxide on the surface, and a metal oxide (MnO₂) grown on the graphene film in the form of a needle may improve the specific capacity and cycling stability of the battery at high current densities by improving the diffusion capability and total migration characteristics of zinc ions.

In particular, the flexible electrode material according to the present disclosure has an effect that is also applicable to an all-solid-state battery using a gel electrolyte.

The free-standing metal oxide is a metal oxide with a form that is standing in a direction perpendicular to the surface of the graphene film, and may be independently bonded without a separate binder or support.

The free-standing metal oxide may be attached to the surface of the graphene film without a separate binder or additive, thereby suppressing a rapid decrease in capacity and decrease in cycling stability of the battery due to the use of a binder or an additive.

That is, the performance of the battery may be improved by preventing side reactions and active material decomposition due to the use of a binder or an additive and improving ion diffusion capability and charge mobility.

According to one embodiment, the free-standing metal oxide may be formed in the form of a needle and may be formed in a direction perpendicular to the surface of the graphene film.

The free-standing metal oxide may be uniformly distributed on the graphene film. The uniform distribution of the free-standing metal oxide may improve the diffusion capability of zinc ions.

According to one embodiment, the graphene film may contain graphene or a plurality of stacked graphenes.

The graphene film may contain one graphene, or may have a form in which a plurality of graphenes is stacked.

The graphene film may have a layered structure containing a plurality of stacked graphenes, and may secure flexibility through this.

The graphene film may serve as a current collector and has an advantage of excellent chemical resistance.

In addition, the electrical conductivity of the metal oxide may be improved to provide excellent electrochemical performance, and help the growth of the free-standing metal oxide.

According to one embodiment, the graphene film may be surface-activated so that a functional group containing oxygen (O) exists on the surface thereof.

In general, the low wettability of graphene acts as a factor that prevents ions in a solution from contacting carbon during aqueous synthesis.

Therefore, the metal oxide may be effectively synthesized on the surface of the graphene film by forming an oxygen-binding functional group on the surface of the graphene film through surface activation, that is, surface functionalization, thereby increasing wettability of the graphene film.

According to one embodiment, the surface activation may be an acid treatment or an etching process using an acid.

The acid treatment or the etching process using an acid may be to use an acidic aqueous solution.

The oxygen-containing functional groups may be formed on the surface of the graphene film through the surface activation, and the metal oxide may be effectively synthesized on the surface of the graphene film by generating surface defects.

According to one embodiment, the graphene film may be impurity-free.

According to one embodiment, the metal oxide may include one or more selected from the group consisting of α-MnO₂, β-MnO₂, γ-MnO₂, b-MnO₂, V₂O₅, and V₂O₅·nH₂O.

The manganese oxide has advantages in that it not only may have low cost, but also may comply with theoretical capacity, and may realize high operating voltage.

According to one embodiment, the metal oxide may be α-MnO₂.

The α-MnO₂ can accommodate a relatively large amount of zinc ions, and thus an effect of increasing the specific capacity of the electrode may be realized.

According to one embodiment, the metal oxide may be contained in an amount of 10% by weight to 10% by weight.

When the metal oxide is contained in an amount of less than the above range, the effect as an active material may not be expressed, and when it is contained in an amount of exceeding the above range, ion diffusion capability and charge mobility may rather deteriorate, resulting in a decrease in electrochemical performance.

According to one embodiment, the metal oxide may have a length of 10 nm to 200 nm in a direction perpendicular to the surface of the graphene film.

Desirably, the metal oxide may have a length of 50 nm to 150 nm in a direction perpendicular to the surface of the graphene film, more desirably, 80 nm to 130 nm, and even more desirably, 100 nm to 120 nm.

If the length in a direction perpendicular to the surface of the graphene film of the metal oxide is less than the above range, electrochemical performance may deteriorate as empty spaces increase on the surface of the graphene film, and if it exceeds the above range, aggregation of the metal oxide may occur to reduce the zinc-ion diffusion capability and charge mobility, thereby deteriorating electrochemical performance and stability.

According to one embodiment, the metal oxide may be directly bonded to the surface of the graphene film.

The metal oxide is directly synthesized and grown on the surface of the graphene film, and may be directly bonded without a separate binder.

According to one embodiment, the flexible electrode material may be binder-free.

That is, since the flexible electrode material according to the present disclosure does not contain a binder or an additive, side reactions and active material decomposition due to the binder or additive may be prevented, and the ion diffusion capability and charge mobility of the electrode may be improved.

According to one embodiment, the electrode may be for a zinc-ion battery.

The zinc-ion battery may be an aqueous zinc-ion battery or an all-solid-state zinc ion battery.

According to one embodiment, the electrode may be a cathode for a zinc-ion battery.

According to one embodiment, the flexible electrode material may be used as a waterproofing electrode.

According to one embodiment, the flexible electrode may have an energy density of 390 Wh/kg or more at a power density of 90 W/kg.

According to one embodiment, the flexible electrode may have a capacity retention rate of 82% or more after 300 cycle charging and discharging at a current density condition of 1.0 A/g.

Another aspect of the present disclosure provides a flexible zinc-ion battery including: a cathode including the flexible electrode material; a zinc metal anode; a separator; and an electrolyte.

The electrolyte may be in a solution or gel state and may include ZnSO₄.

That is, the flexible electrode material according to the present disclosure has characteristics applicable to both zinc-ion batteries and all-solid-state zinc batteries.

In particular, it has excellent flexibility and waterproofness, thereby having characteristics capable of exhibiting excellent performance even in an underwater state and a folded state.

Another aspect of the present disclosure provides a method for preparing a flexible electrode material, the method including the steps of: preparing a mixed solution by dissolving graphene and polyvinylidene difluoride (PVDF) in a solvent; casting the mixed solution on a mesh and heating it to form a graphene film; separating the graphene film from the mesh; and floating the graphene film on a metal oxide precursor solution and then stirring the metal oxide precursor solution.

In the step of preparing the mixed solution, an organic solvent may be used as the solvent. For example, N-methyl-2-pyrrolidone may be used as the solvent.

According to one embodiment, the dissolution may be performed at a temperature of 50° C. to 100° C. for 30 minutes to 2 hours.

According to one embodiment, the mixed solution may be cast on a mesh by a doctor blade method, and the heating may be performed at a temperature of 50° C. to 150° C.

The heating may be performed in an oven at a temperature of 50° C. to 150° C., and a graphene film may be formed through the heating and drying.

According to one embodiment, it may further include a step of surface-activating the separated graphene film after the step of separating the graphene film from the mesh.

The surface activation may be an acid treatment or an etching process using an acid.

The surface activation may be performed for 10 minutes to 120 minutes, desirably, for 30 minutes to 90 minutes.

The surface activation may promote a reaction between the mixed solution and carbon of the graphene film by forming an oxygen-containing functional group on the surface of the graphene film and thus increasing wettability, and may enable a metal oxide to effectively grow by generating some defects on the surface of the graphene film.

The metal oxide precursor solution refers to a solution containing a reactant for generating a target metal oxide.

According to one embodiment, the metal oxide may be manganese oxide, and the metal oxide precursor solution may contain potassium permanganate (KMnO₄), sulfuric acid (H₂SO₄), and deionized water (DIW).

According to one embodiment, the manganese oxide may be synthesized through the reaction formula as below.

H₂O+3C+4MnO₄⁻->4MnO₂+2HCO₃+CO₃²⁻

According to one embodiment, the stirring may be performed for 30 minutes to 90 minutes.

As the stirring time is controlled, the size and the length in the vertical direction of the metal oxide to be synthesized may be controlled.

Desirably, the stirring may be performed for 40 minutes to 80 minutes, more desirably, for 50 minutes to 70 minutes.

The stirring time is a reaction time for synthesizing a metal oxide, and a metal oxide having an appropriate size and length may be formed by adjusting the reaction time.

Another aspect of the present disclosure provides a zinc-ion battery including: a cathode including the flexible electrode material or a flexible electrode material prepared by the preparation method; an anode containing zinc metal; a separator; and an electrolyte.

The electrolyte may be in a solution or gel state.

Another aspect of the present disclosure provides an energy storage device including the zinc-ion battery.

The energy storage device may be an all-solid-state device.

Hereinafter, the present disclosure will be described in more detail by Examples and Comparative Example.

However, the following Examples are only for illustrating the present disclosure, and the content of the present disclosure is not limited to the following Examples.

### Examples. Preparation of Flexible Electrode Materials

### 1) Manufacture of Graphene Film

Graphene and polyvinylidene fluoride (PVDF) were dissolved in N-methyl-2-pyrrolidone at 80° C. for 1 hour.

The mixed solution was cast on a stainless steel mesh by a doctor blade method and then dried by heating in an oven at 100° C.

After separating a formed graphene film from the mesh, the surface of the graphene film was activated by performing etching in a 1 M hydrochloric acid (HCl) for 1 hour.

### 2) Preparation of Flexible Electrode Materials

The surface-activated graphene film (FGF) was washed several times with deionized water and dried. The surface-activated graphene film was floated on a mixed solution of 18 mM potassium permanganate (KMnO₄), 1 M sulfuric acid (H₂SO₄), and deionized water (DIW), and then the solution was stirred at 80° C. for 30, 60, or 90 minutes to obtain flexible electrode materials in which free-standing manganese dioxide (MnO₂) was synthesized on the graphene film.

After that, the flexible electrode materials were washed with deionized water and dried.

Hereinafter, they are indicated as Example 1 (30 minutes), Example 2 (60 minutes), and Example 3 (90 minutes) depending on the stirring time.

### Experimental Example 1. Confirmation of Morphological and Structural Characteristics of Flexible Electrode Materials

The morphological and structural characteristics of the flexible electrode materials prepared in Examples were analyzed through field emission scanning electron microscopy (FE-SEM), high-resolution transmission electron microscopy (HR-TEM), and energy dispersive spectroscopy (EDS).

In addition, the crystal phase of manganese dioxide formed on the Examples was analyzed through X-ray diffraction analysis (XRD), and the composition was analyzed through a thermogravimetric analyzer (TGA) under ambient air in the temperature range of 100° C. to 900° C.

The chemical bonding state was analyzed by X-ray photoelectron spectroscopy (XPS).

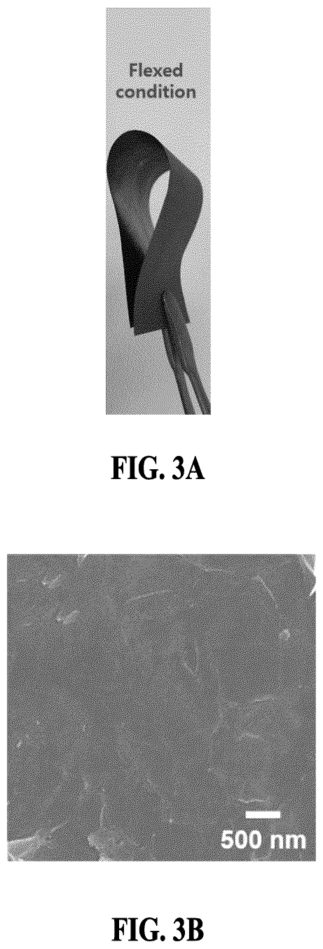

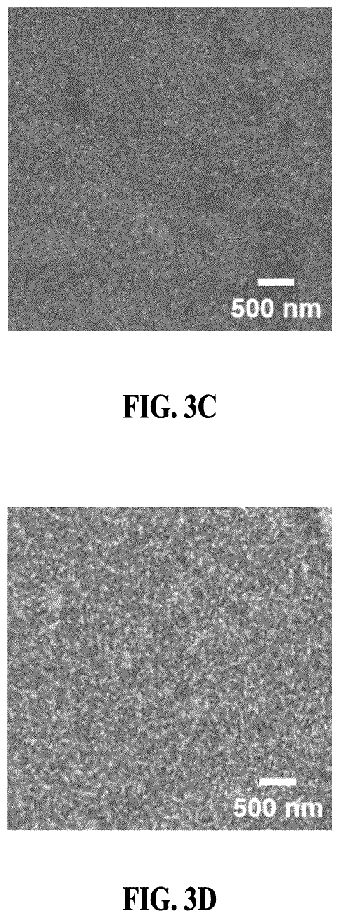

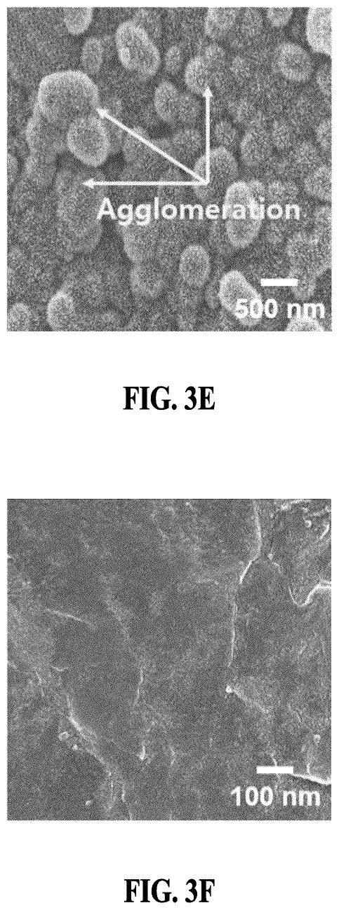

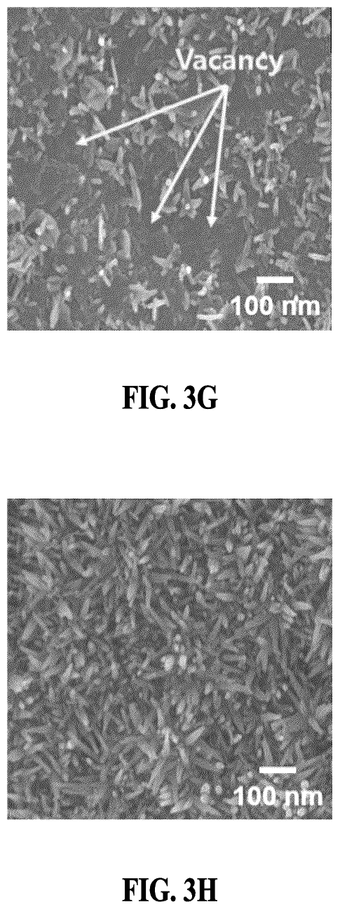

FIG. 3 is images showing morphological and structural characteristics of a flexible electrode material according to one embodiment of the present disclosure.

FIG. 3A is a photograph showing a flexed condition of a surface-activated graphene film.

FIGS. 3B and 3E are FE-SEM images of surface-activated graphene films.

FIGS. 3C and 3G are FE-SEM images of the flexible electrode material of Example 1.

FIGS. 3D and 3H are FE-SEM images of the flexible electrode material of Example 2.

FIGS. 3E and 3I are FE-SEM images of the flexible electrode material of Example 3.

Referring to FIGS. 3A to 31, it can be confirmed that MnO₂ grows more as the growth time through stirring increases.

In the case of Example 1, empty spaces appeared due to the short growth time (30 minutes), and in the case of Example 3, agglomeration of MnO₂ occurred due to the long growth time (90 minutes).

In comparison, in the case of Example 2, it can be confirmed that MnO₂ grew with a uniform distribution on the surface of the graphene film.

In addition, in the case of Example 1, small and ambiguous needle-shaped particles with many empty spaces appeared in a relatively wide size distribution (22.3 to 81.6 nm), and in the case of Example 3, large needle-shaped MnO₂ along with signs of agglomeration appeared in a wider size distribution (128.2 to 137.6 nm).

In comparison, it can be confirmed in the case of Example 2 that distinct needle-shaped MnO₂ well dispersed on the surface of surface-activated graphene without empty spaces or agglomeration appeared in a relatively uniform size distribution (103.7 to 110.2 nm).

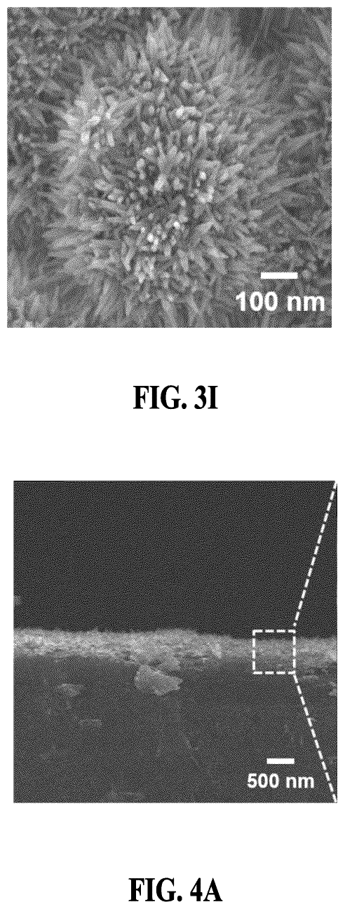

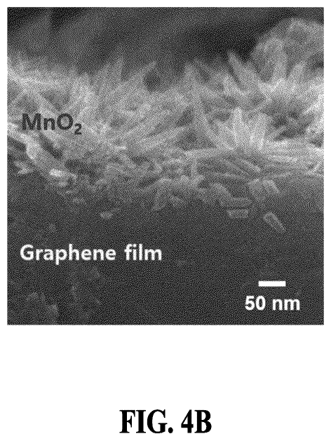

FIG. 4 is cross-sectional FE-SEM images of the flexible electrode material of Example 2 according to one embodiment of the present disclosure.

FIG. 4A is a cross-sectional FE-SEM image (scale bar 500 nm) of the flexible electrode material of Example 2 according to one embodiment of the present disclosure.

FIG. 4B is a cross-sectional FE-SEM image (scale bar 50 nm) of the flexible electrode material of Example 2 according to one embodiment of the present disclosure, which is an enlarged view of the rectangular marked portion of FIG. 4A.

Referring to FIG. 4, it can be confirmed that MnO₂ was well fixed and dispersed on the surface-activated graphene film.

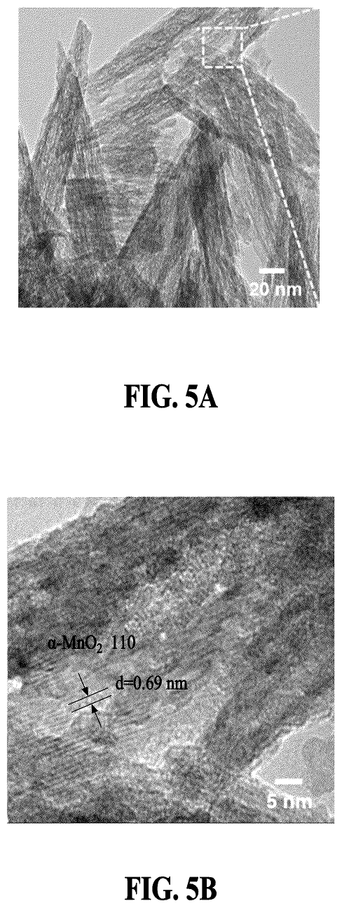

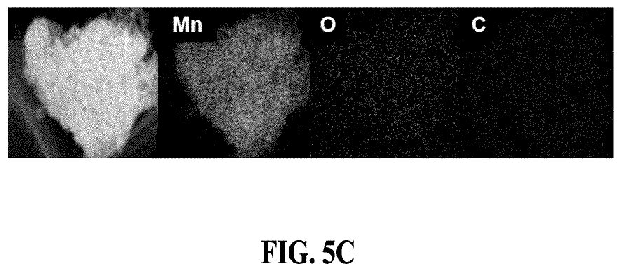

FIG. 5 is HR-TEM images and EDS mapping images of the flexible electrode material of Example 2 according to one embodiment of the present disclosure.

FIG. 5A is a low-resolution HR-TEM image of the flexible electrode material of Example 2.

FIG. 5B is a high-resolution HR-TEM image of the flexible electrode material of Example 2, which is an enlarged view of the rectangular marked portion of FIG. 5A.

Referring to FIGS. 5A and 5B, needle-shaped MnO₂ in the size range of 101.3 to 118.1 nm formed on the flexible electrode material can be confirmed. In addition, it can be confirmed that the lattice distance of 0.69 nm was shown, and this coincided with the (110) plane of α-MnO₂.

FIG. 5C is EDS mapping images of the flexible electrode material of Example 2.

Referring to FIG. 5C, it can be confirmed that manganese, oxygen, and carbon were uniformly dispersed on the surface of the flexible electrode material.

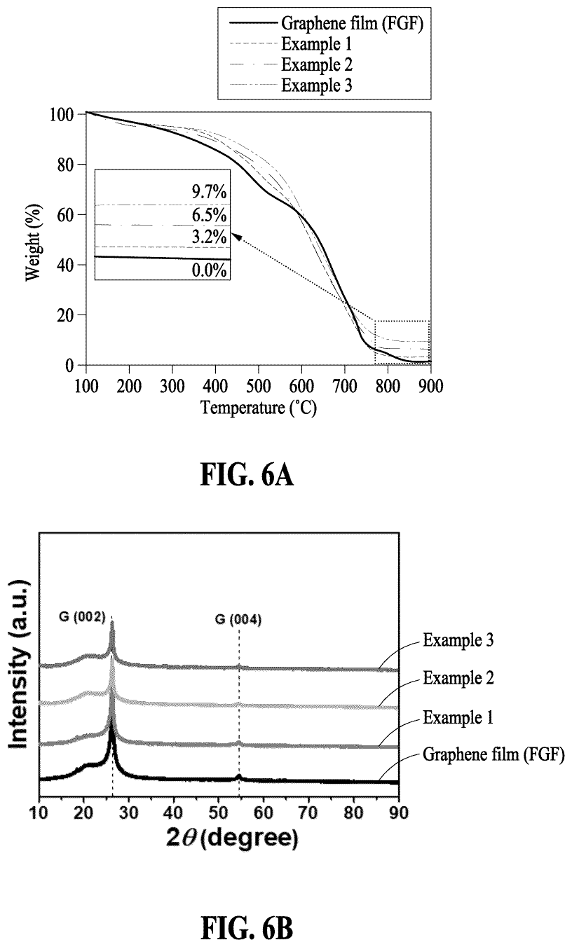

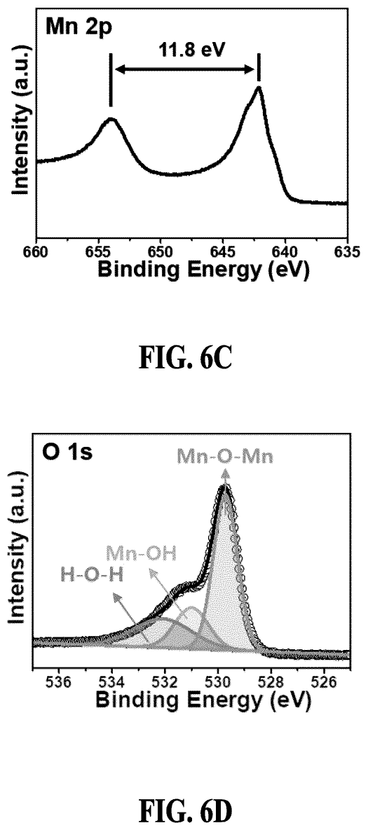

FIG. 6 is TGA, XRD, and XPS results of a flexible electrode material according to one embodiment of the present disclosure.

FIG. 6A is a TGA result of a flexible electrode material according to one embodiment of the present disclosure.

Referring to FIG. 6A, it can be confirmed that the surface-activated graphene film exhibited 100% weight loss, and through this, it can be seen that the graphene film had a pure carbon composition and did not contain impurities.

In comparison, in Examples 1 to 3, the weight loss was exhibited to be 3.2%, 6.5%, and 9.7%, respectively, and it means that more MnO₂ grew on the surface of the surface-activated graphene film with increasing treatment time.

FIG. 6B is an XRD result of a flexible electrode material according to one embodiment of the present disclosure.

Referring to FIG. 6B, it can be confirmed that peaks appeared at 26.5° and 54.6° corresponding to the (002) and (004) layers of graphite in both the surface-activated graphene film and Examples 1 to 3, and it can be confirmed through this that graphene was stacked to create a layered structure. This was not confirmed since the weight of MnO₂ in Examples 1 to 3 was less than 10% by weight.

FIGS. 6C and 6D are XPS results of a flexible electrode material according to one embodiment of the present disclosure.

Referring to FIGS. 6C and 6D, it can be confirmed that the Mn 2p shoulder peaks at 654.5 eV and 642.7 eV coincided with the general spin energy separation of 11.8 eV for MnO₂, and it can be confirmed that the peaks in 532.6 eV, 531.5 eV, and 530.2 eV in the O is spectrum corresponded to H—O—H, hydrated trivalent Mn—OH, and tetravalent Mn—O—Mn bonds, respectively.

Through this, it can be seen that α-MnO₂ was successfully synthesized on the surface of the surface-activated graphene film.

### Experimental Example 2. Evaluation of Electrochemical Properties of Zinc-Ion Batteries Using Flexible Electrode Materials

CR2032-type coin cells were manufactured by using the flexible electrode materials prepared in Examples as a cathode, zinc metal as an anode, glass fiber paper as a separator, and 2 M zinc sulfate (ZnSO₄) as an electrolyte.

Electrochemical behaviors were analyzed through electrochemical impedance spectroscopy (EIS) and cyclic voltammetry (CV) by using the cells.

Rate performance tests were performed in the potential range of 1.0 to 1.9 V (vs Zn/Zn²⁺) at current densities of 0.1, 0.3, 0.5, 0.7, 1.0, 1.3, 1.5, and 2.0 Ag⁻¹, and long-term cycling tests were performed at a current density of 1.0 Ag⁻¹ for up to 300 cycles.

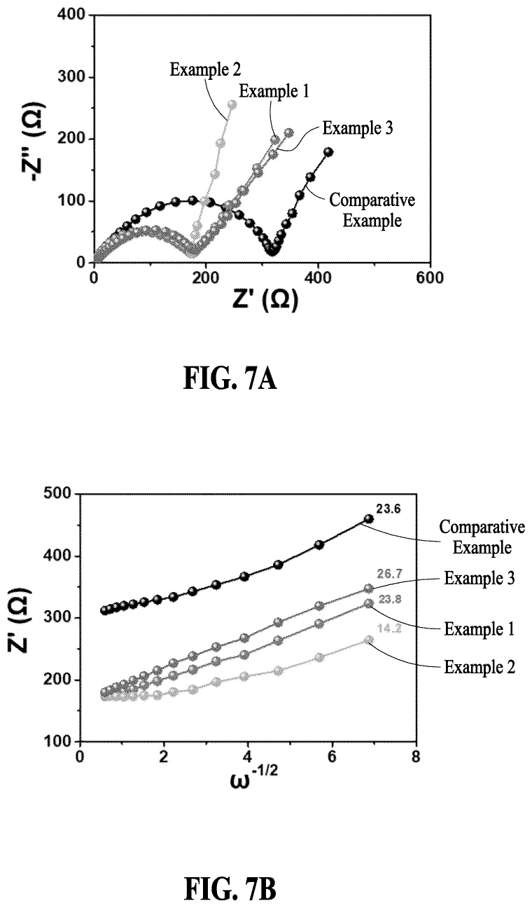

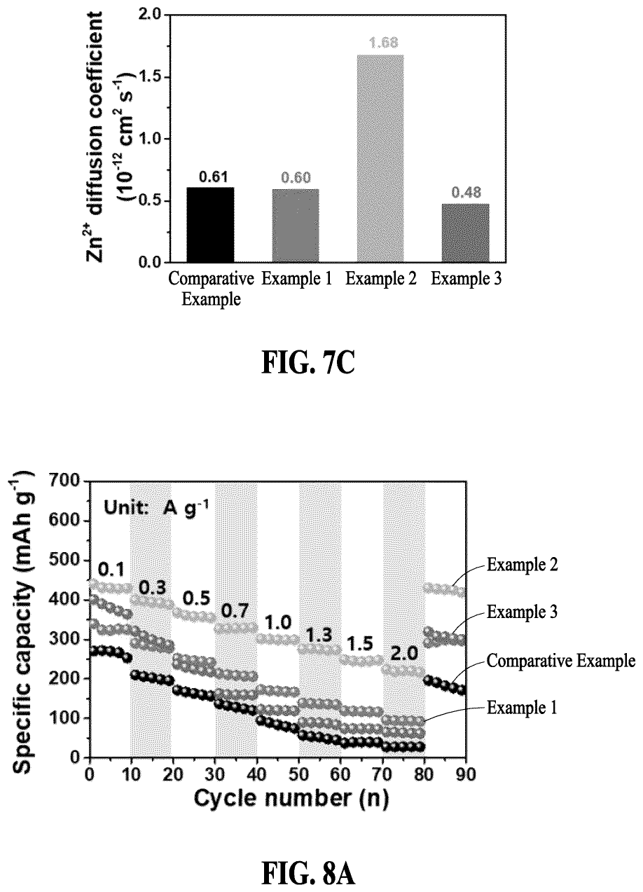

FIG. 7 is results of analyzing the electrochemical properties of coin cells manufactured of electrode materials of Comparative Example and Examples 1 to 3 in which a commercialized MnO₂ powder, a PVDF binder, and conductive carbon black (Ketjen black) are cast on a surface-activated graphene film.

FIG. 7A is a Nyquist plot of cells manufactured using the electrode materials of Comparative Example and Examples 1 to 3. Here, the semicircle of the high-frequency region and the slope of the low-frequency region represent charge transfer resistance (Rct) and ion diffusion behavior (Warburg impedance).

Referring to FIG. 7A, it can be confirmed that in the case of Embodiments, the semicircles were shown to be smaller than that of Comparative Example, this is because there was no binder that could impede the access of active materials.

In addition, in the case of Example 2, it can be seen that the steepest slope, that is, the lowest Warburg impedance was exhibited, and the zinc-ion diffusion capability was the most excellent.

The Warburg impedance coefficient (aw) was calculated using Equation 1, and the Zn-ion diffusion coefficient (D) was calculated using Equation 2.

$${Z}_{real} = {R}_{e} + {R}_{ct} + {σ}_{w} {ω}^{- \frac{1}{2}} \qquad [ Equation 1 ]$$

$$D = {R}^{2} {T}^{2} / 2 {A}^{2} {n}^{2} {F}^{4} {C}^{2} {σ}_{w}^{2} \qquad [ Equation 2 ]$$

Here, Rₑ represents the type of total electrode resistance, called bulk resistance, D is a Zn-ion diffusion coefficient, R is a gas constant, T is a temperature, A is an area of the electrode, n is the number of electrons per molecule, F is a Faraday constant, and C is a Zn ion molar concentration.

FIG. 7B is a graph showing the relationship between Zᵣₑₐₗ and [symbol] in cells manufactured using the electrode materials of Comparative Example and Examples 1 to 3.

Referring to FIG. 7B, it can be seen that the Warburg impedance coefficients (aw) calculated through this correspond to 23.6, 23.8, 14.2, and 26.7 Ω cm² [symbol] , respectively, in the order of Comparative Example and Examples 1 to 3.

FIG. 7C is a graph showing Zn-ion diffusion coefficients of cells manufactured using the electrode materials of Comparative Example and Examples 1 to 3.

Zn-ion diffusion coefficients were calculated to be 0.61, 0.60, 1.68, and 0.48×10⁻¹² cm² s⁻¹, respectively, in the order of Comparative Example and Examples 1 to 3.

Through this, it can be seen that the diffusion performance of zinc ions is increased in Example 2 in which MnO₂ was evenly dispersed without a binder.

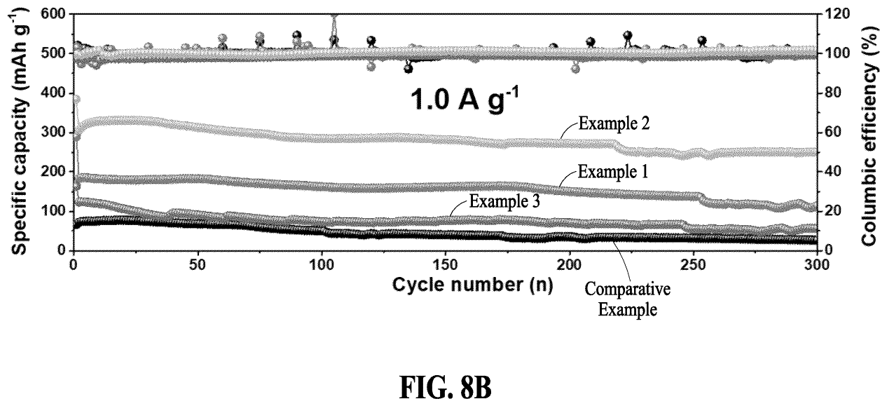

FIG. 8 is graphs showing the electrochemical performance of cells manufactured using the electrode materials of Comparative Example and Examples 1 to 3.

FIG. 8A shows the rate performance of cells manufactured using the electrode materials of Comparative Example and Examples 1 to 3 at potentials in the range of 1.0 to 1.9 V and current densities in the range of 0.1 to 2.0 Ag⁻¹.

Referring to FIG. 8A, it can be confirmed that Example 2 exhibited a high specific capacity and exhibited an excellent recovering capacity of 430.5 mAhg⁻¹ at 0.1 Ag⁻¹ (capacity retention rate of 97.8%).

In comparison, Example 1 exhibited a low discharge capacity, and Example 3 exhibited a rapid loss of discharge capacity and a low capacity retention rate (80.0%).

FIG. 8B is a graph showing the capacity changes during 300 cycles at a current density of 1.0 Ag⁻¹ of cells manufactured using the electrode materials of Comparative Example and Examples 1 to 3.

Referring to FIG. 8B, it can be confirmed that the capacity retention rates of 37.2%, 62.8%, 82.7%, and 45.8% were exhibited in the order of Comparative Example and Examples 1 to 3, respectively.

Through this, it can be seen that all of Examples showed improved capacity retention rates than Comparative Example, and in the case of Example 2, a capacity retention rate of 82% or more was secured, indicating the most excellent long-term stability.

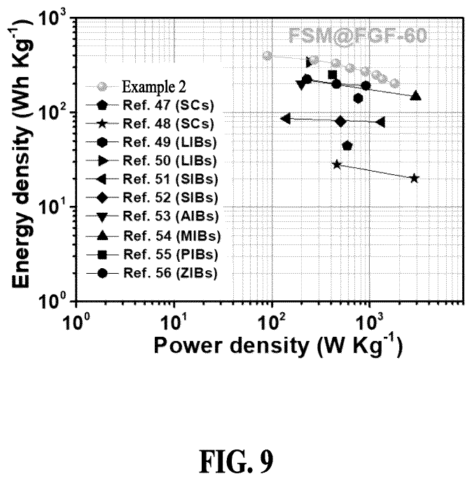

FIG. 9 compares the energy and power densities of the cell manufactured using the electrode material of Example 2 with other reported energy storage devices using an electrolyte solution by Ragone plot.

Referring to FIG. 9, it can be confirmed that Example 2 exhibited a maximum energy density of 396 W h kg⁻¹ at a power density of 90 W kg⁻¹, and exhibited a maximum energy density of 201 W h kg⁻¹ at a power density of 1,800 W kg⁻¹.

That is, it can be seen that the cell using the electrode material of Example 2 exhibited high power density and energy density compared to previously reported supercapacitors, lithium-ion batteries, sodium-ion batteries, aluminum-ion batteries, magnesium-ion batteries, and potassium-ion batteries.

### Experimental Example 3. Evaluation of Electrochemical Properties of all-Solid-State Zinc Ion Batteries Using Flexible Electrode Materials

In addition, an all-solid-state zinc ion battery was manufactured by including the flexible electrode material prepared in Example as a cathode, zinc metal as an anode, glass fiber paper as a separator, and a gel in which 1 M zinc sulfate (ZnSO₄), 1.5 M polyvinyl alcohol (PVA), and deionized water (DIW) are mixed as an electrolyte.

The all-solid-state zinc ion battery was wrapped with a sealing film as an exterior material, and the electrochemical behaviors were investigated through EIS by using an AC signal of 5 mV in the frequency range of 105 to 10⁻² Hz.

Rate performance tests were performed at current densities of 0.3, 0.5, and 1.0 A g⁻¹, and long-term cycling tests were performed in a condition in which the samples were immersed in water in a flat and folded state up to 100 cycles at a current density of 0.5 A g⁻¹.

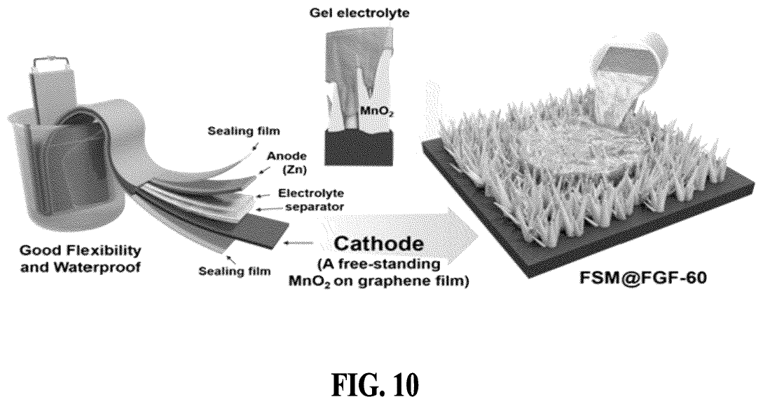

FIG. 10 shows a schematic diagram of the structure of an all-solid-state zinc ion battery using a flexible electrode material wheat gel electrolyte according to one embodiment of the present disclosure.

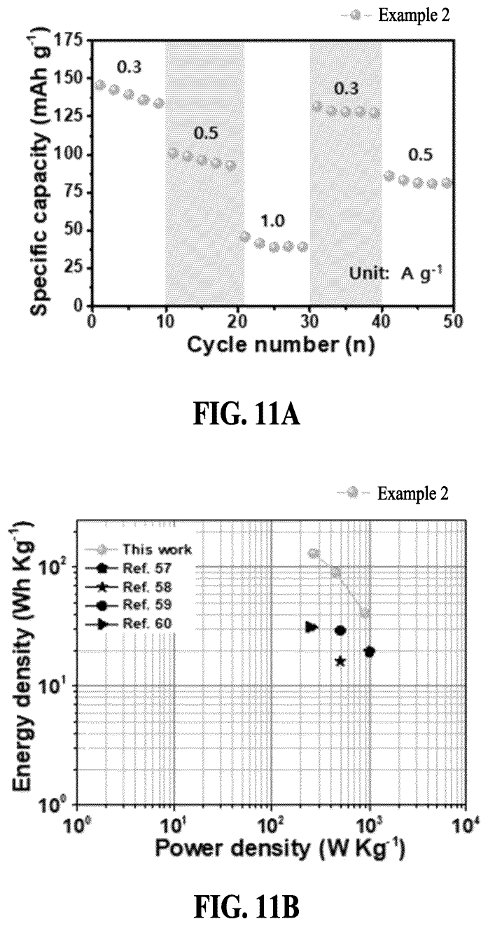

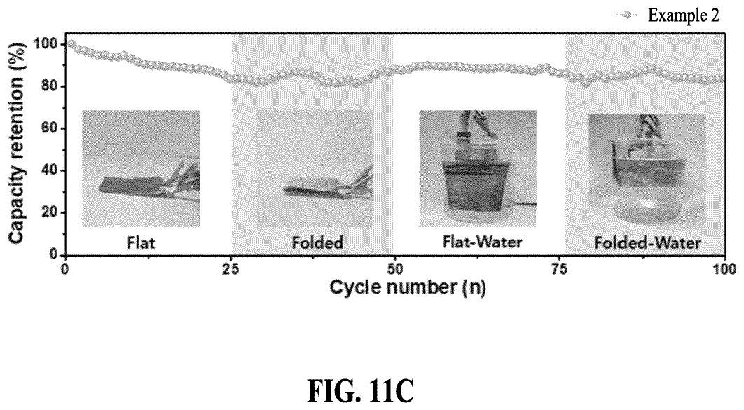

FIG. 11 shows life performance and cycling stability of an all-solid-state zinc ion battery using a flexible electrode material wheat gel electrolyte according to one embodiment of the present disclosure.

FIG. 11A shows the rate performance of an all-solid-state zinc ion battery according to one embodiment of the present disclosure at a potential in a range of 1.0 to 1.9 V and a current density in a range of 0.3 to 1.0 Ag⁻¹.

Referring to FIG. 11A, it can be confirmed that the all-solid-state zinc ion battery provided excellent specific capacities of 145.6, 100.8, and 45.6 mA h g⁻¹ at current densities of 0.3, 0.5, and 1.0 A g⁻¹, and exhibited a recovering capacity of 131.6 mAhg⁻¹ at 0.3 A g⁻¹ (capacity retention rate of 90.4%).

FIG. 11B is a Ragone plot comparing the energy and power densities of an all-solid-state zinc ion battery according to one embodiment of the present disclosure with previously reported all-solid-state energy storage devices.

Referring to FIG. 11B, it can be confirmed that the all-solid-state zinc ion battery according to one embodiment of the present disclosure exhibited an energy density of 131 Wkg⁻¹ at a power density of 270 Whkg⁻¹, and it can be seen that this is the energy density that is superior to those of the previously reported all-solid-state energy storage devices.

FIG. 11C shows cycling stability at a current density of 0.5 Ag⁻¹ under conditions of flat and folded states and the presence and absence of water of an all-solid-state zinc ion battery according to one embodiment of the present disclosure.

Referring to FIG. 11C, it can be confirmed that the all-solid-state zinc ion battery according to one embodiment of the present disclosure exhibited a capacity retention rate of 85% or more for 100 cycles in all states, and thus had waterproofness together with high flexibility.

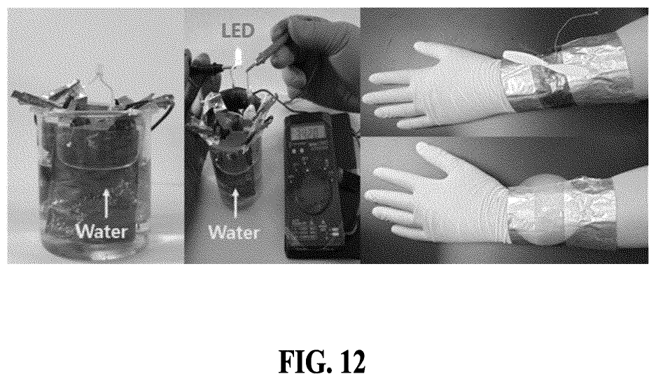

FIG. 12 is photographs of experiment confirming whether or not the all-solid-state zinc ion battery according to one embodiment of the present disclosure operates under water and in a flexed condition.

Referring to FIG. 12, it can be confirmed that the all-solid-state zinc ion battery according to one embodiment of the present disclosure illuminated a light emitting diode (LED) in water and operated a drone propeller in a flexed condition.

Through this, it can be seen that the all-solid-state zinc ion battery according to one embodiment of the present disclosure may be practically used as an energy storage device having excellent electrochemical performance, flexibility, and waterproof characteristics.

Although the above-mentioned examples have been described by limited drawings, those skilled in the art may apply various technical modifications and variations based on the above-mentioned description. For example, appropriate results may be achieved although described techniques are carried out in a different order from a described method, and/or described elements such as a system, structure, apparatus, circuit, etc. are combined or mixed in a different form from the described method, or replaced or substituted by other elements or equivalents.

Therefore, other implementations, other examples, and equivalents to the claim scope also belong to the scope of the following claims.

1. A flexible electrode material comprising:
a graphene film; and
a free-standing metal oxide formed on the graphene film.

2. The flexible electrode material of claim 1, wherein the graphene film contains graphene or a plurality of stacked graphenes.

3. The flexible electrode material of claim 1, wherein the graphene film is surface-activated so that a functional group containing oxygen (O) exists on a surface.

4. The flexible electrode material of claim 1, wherein the metal oxide comprises one or more selected from the group consisting of α-MnO₂, β-MnO₂, γ-MnO₂, δ-MnO₂, V₂O₅, and V₂O₅·nH₂O, and the metal oxide is contained in an amount of 1% by weight to 10% by weight.

5. The flexible electrode material of claim 1, wherein the metal oxide has a length of 10 nm to 200 nm in a direction perpendicular to a surface of the graphene film.

6. The flexible electrode material of claim 1, wherein the metal oxide is directly bonded to a surface of the graphene film.

7. The flexible electrode material of claim 6, wherein the flexible electrode material is binder-free.

8. The flexible electrode material of claim 1, wherein the electrode is for a zinc ion battery.

9. A method for preparing a flexible electrode material, the method comprising:
preparing a mixed solution by dissolving graphene and polyvinylidene difluoride (PVDF) in a solvent;
casting the mixed solution on a mesh and heating it to form a graphene film;
separating the graphene film from the mesh; and
floating the graphene film on a metal oxide precursor solution and then stirring the metal oxide precursor solution.

10. The method of claim 9, wherein the mixed solution is cast on the mesh by a doctor blade method, and the heating is performed at a temperature of 50° C. to 150° C.

11. The method of claim 9, wherein the metal oxide is manganese oxide, and the metal oxide precursor solution contains potassium permanganate (KMnO₄), sulfuric acid (H₂SO₄), and deionized water (DIW).
